(19) United States
(12) Patent Application Publication
(10) Pub. No.: US 2012/0102527 A1
(43) Pub. Date: Apr. 26, 2012

(54) TV system generating three-dimensional parameters according to a classification of a three-dimensional TV program and method thereof

(76) Inventors: Hsuan-Ching Liu, Tainan County (TW); Shu-Ming Liu, Tainan County (TW)

(21) Appl. No.: 12/910,847

(22) Filed: Oct. 24, 2010

(51) Int. Cl. H04N 5/445

(52) U.S. Cl. 725/45; 725/39; 725/51

(57) ABSTRACT

After receiving an electronic program guide, generate three-dimensional parameters corresponding to a three-dimensional TV program listed on the electronic program guide according to the classification of the three-dimensional TV program, then display the three-dimensional TV program on a three-dimensional TV set according to the three-dimensional parameters.

### BACKGROUND OF THE INVENTION

1. Field of the Invention

The present invention is related to a TV system and method thereof, and particularly to a TV system generating three-dimensional parameters according to a classification of a three-dimensional TV program and method thereof.

2. Description of the Prior Art

When a three-dimensional TV set receives a three-dimensional program or converts a two-dimensional program into a three-dimensional program, the three-dimensional TV set also receives three-dimensional parameters of the three-dimensional program and displays the three-dimensional program according to the three-dimensional parameters. In the prior art, the three-dimensional parameters are global parameters, that is, the three-dimensional parameters are applied to all classifications of three-dimensional programs.

However, contents between different classifications of three-dimensional programs may require quite different three-dimensional emphasis. For example, in a talk show program, the host and guest may only make minor movements while the background remains almost unchanged. In a sports program, the background changes almost all the time with the displacements of athletes. If global three-dimensional parameters are applied to all kinds of three-dimensional programs, then a program which should not put stress on three-dimensional effects may end up emphasizing the three-dimensional effects and vice versa. Thus it is improper to use global three-dimensional parameters for all classifications of three-dimensional programs.

### SUMMARY OF THE INVENTION

An embodiment of the present invention provides a method of generating three-dimensional parameters according to a classification of a three-dimensional TV program. The method includes receiving an electronic program guide, generating the three-dimensional parameters of the three-dimensional TV program listed on the electronic program guide according to the classification of the three-dimensional TV program, and displaying the three-dimensional TV program on a three-dimensional TV set according to the three-dimensional parameters.

Another embodiment of the present invention provides a TV system generating three-dimensional parameters according to a classification of a three-dimensional TV program. The TV system includes a receiver, a three-dimensional parameter generator, and a three-dimensional TV set. The receiver is used for receiving an electronic program guide. The three-dimensional parameter generator is used for generating three-dimensional parameters of the three-dimensional TV program listed on the electronic program guide according to the classification of the three-dimensional TV program. And the three-dimensional TV set is used for displaying the three-dimensional TV program according to the three-dimensional parameters.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a TV system generating three-dimensional parameters according to a classification of a three-dimensional TV program according to an embodiment of the present invention.

FIG. 2 is a flowchart illustrating a method of generating three-dimensional parameters according to a classification of a three-dimensional TV program according to an embodiment of the present invention.

### DETAILED DESCRIPTION

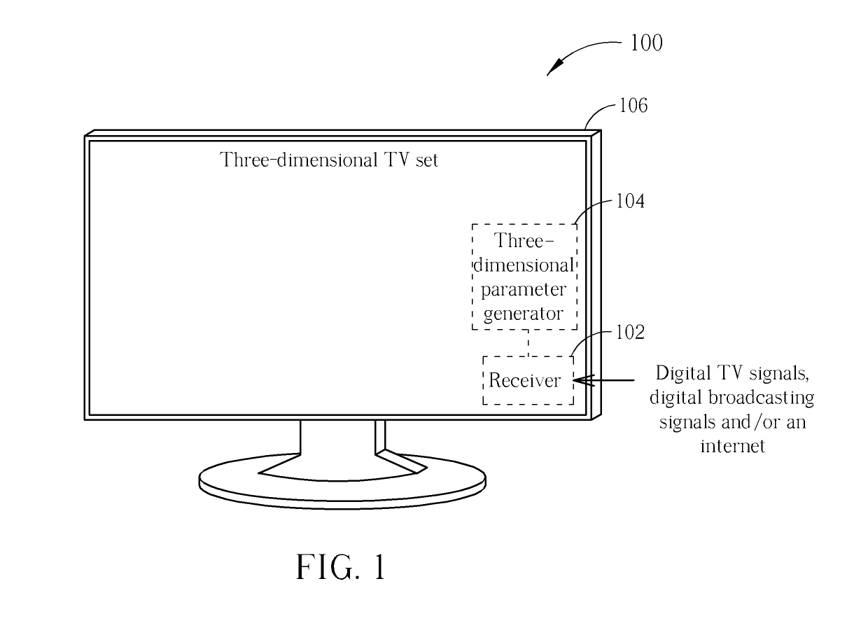

Please refer to FIG. 1. FIG. 1 is a diagram illustrating a TV system 100 generating three-dimensional parameters according to a classification of a three-dimensional TV program according to an embodiment of the present invention. The TV system 100 includes a receiver 102, a three-dimensional parameter generator 104, and a three-dimensional TV set 106. The receiver 102 is used for receiving an electronic program guide EPG from digital TV signals, digital broadcasting signals and/or internet. The electronic program guide EPG includes the classification, playing channel, and playing time of the three-dimensional TV program. The three-dimensional parameter generator 104 is used for generating three-dimensional parameters of the three-dimensional TV program listed on the electronic program guide EPG according to the classification of the three-dimensional TV program. The three-dimensional parameters include a depth, a background color, a three-dimensional contrast, and/or a main character where the depth of the three-dimensional parameters is a global depth plus/minus a local depth. The three-dimensional TV set 106 is used for displaying the three-dimensional TV program according to the three-dimensional parameters of the three-dimensional TV program generated by the three-dimensional parameter generator 104.

The three-dimensional TV program may be classified as a movie program, a talk show, a sports program, a music video program, etc. Generally movie scenes change very fast. Sometimes a movie program may display great mountains and rivers; sometimes it may display monotonous indoor scenes. In a talk show program, the host and guest may only make minor movement while the background remains almost unchanged. In a sports program, the background changes almost all the time with the displacements of athletes. In the music video program, the background remains almost unchanged while the singer and dancers make great body movements. Therefore, after the TV system 100 receives the electronic program guide EPG, the three-dimensional parameter generator 104 generates the three-dimensional parameters of the three-dimensional TV program listed on the electronic program guide EPG according to the classification of the three-dimensional TV program. And the three-dimensional parameter generator 104 utilizes the global depth plus/minus the local depth to generate the depth of the three-dimensional parameters of the three-dimensional TV program. For example, the background of a talk show program hardly changes, and the host and guests may make small movements, thus the three-dimensional effect on the background can be minimized while the host and guests may be emphasized. This can reduce the amount of three-dimensional operations of the three-dimensional parameter generator 104. In addition, in a movie program, the three-dimensional effect may stress on the great mountains and rivers.

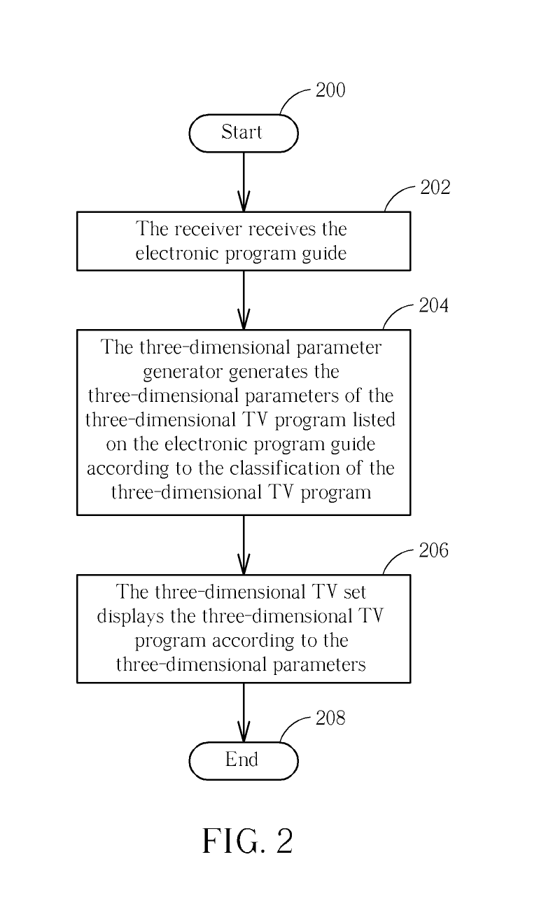

Please refer to FIG. 2. FIG. 2 is a flowchart illustrating a method of generating three-dimensional parameters according to a classification of a three-dimensional TV program according to an embodiment of the present invention. The method in FIG. 2 is illustrated with the TV system 100 in FIG. 1. Detailed steps are as follows:

Step 200: Start;

Step 202: The receiver 102 receives the electronic program guide EPG;

Step 204: The three-dimensional parameter generator 104 generates the three-dimensional parameters of the three-dimensional TV program listed on the electronic program guide EPG according to the classification of the three-dimensional TV program;

Step 206: The three-dimensional TV set 106 displays the three-dimensional TV program according to the three-dimensional parameters;

Step 208: End.

In Step 202, the receiver 102 receives the electronic program guide EPG from the digital broadcasting signals, digital TV signals and/or internet. In Step 204, the three-dimensional parameter generator 104 generates three-dimensional parameters of three-dimensional TV programs according to the classifications of the three-dimensional TV programs listed on the electronic program guide EPG before the show time of the three-dimensional TV programs. For example, before the midnight, the three-dimensional parameter generator 104 may generate three-dimensional parameters of every three-dimensional TV program of each channel listed on the electronic program guide EPG for the coming day. Thus during the display time of the three-dimensional TV program, the three-dimensional parameter is applied to the channel for displaying the three-dimensional TV program. In Step 206, the three-dimensional TV set 106 displays the three-dimensional TV program according to the three-dimensional parameters of the three-dimensional TV program.

To sum up, the TV system generates three-dimensional parameters of a three-dimensional TV program according to the classification of the three-dimensional TV program listed on the electronic program guide. Therefore, optimal three-dimensional effects can be applied to three-dimensional TV programs to improve the display quality of three-dimensional TV programs.

Those skilled in the art will readily observe that numerous modifications and alterations of the device and method may be made while retaining the teachings of the invention.

What is claimed is:

1. A method of generating three-dimensional parameters according to a classification of a three-dimensional TV program, the method comprising:
receiving an electronic program guide;
generating the three-dimensional parameters of the three-dimensional TV program listed on the electronic program guide according to the classification of the three-dimensional TV program; and
displaying the three-dimensional TV program on a three-dimensional TV set according to the three-dimensional parameters.

2. The method of claim 1, wherein receiving the electronic program guide is receiving the electronic program guide from digital broadcasting signals.

3. The method of claim 1, wherein receiving the electronic program guide is receiving the electronic program guide from digital TV signals.

4. The method of claim 1, wherein receiving the electronic program guide is receiving the electronic program guide from internet.

5. The method of claim 1, wherein the three-dimensional TV program is classified as a movie program, a talk show, a sports program, or a music video program.

6. The method of claim 1, wherein the three-dimensional parameters include a depth, a background color, a three-dimensional contrast, and/or a main character.

7. The method of claim 6, wherein the depth is a global depth plus/minus a local depth.

8. A TV system generating three-dimensional parameters according to a classification of a three-dimensional TV program, the TV system comprising:
a receiver for receiving an electronic program guide;
a three-dimensional parameter generator for generating the three-dimensional parameters of the three-dimensional TV program listed on the electronic program guide according to the classification of the three-dimensional TV program; and
a three-dimensional TV set for displaying the three-dimensional TV program according to the three-dimensional parameters.

9. The TV system of claim 8, wherein the three-dimensional parameters include a depth, a background color, a three-dimensional contrast, and/or a main character.

10. The TV system of claim 9, wherein the depth is a global depth plus/minus a local depth.
